(19) United States
(12) Patent Application Publication
(10) Pub. No.: US 2022/0211104 A1
(43) Pub. Date: Jul. 7, 2022

(54) An Aerosol Generating Device

(71) Applicant: JT International S.A., Geneva (CH)

(72) Inventors: Marko Plevnik, London (GB); Norihiko Inoue, London (GB)

(73) Assignee: JT International S.A., Geneva (CH)

(21) Appl. No.: 17/611,371

(22) PCT Filed: Jun. 5, 2020
(86) PCT No.: PCT/EP2020/065638

§ 371 Date: Nov. 15, 2021

(30) Foreign Application Priority Data
Jun. 7, 2019 (EP) 19178955.1

(51) Int. Cl. A24F 40/40; A24F 40/10

(52) U.S. Cl. CPC A24F 40/40; A24F 40/10

(57) ABSTRACT

An aerosol generating device includes a heating chamber arranged to receive a consumable along a first direction and heat the consumable to generate an inhalable vapour, and a grip for holding the device, wherein the first direction and the longitudinal axis of the device are angularly offset from each other. By providing an aerosol generating device configured in this manner the smoking experience of the user is enhanced.

### TECHNICAL FIELD

The present disclosure relates to an aerosol generating device and an aerosol generating system comprising the aerosol generating device and a consumable.

### TECHNICAL BACKGROUND

Aerosol generating devices such as electronic cigarettes are relatively well known and are becoming increasingly popular with consumers in recent years. A common operating principle for such electronic cigarettes is to heat a consumable without burning it to provide an aerosol (also referred to as a vapour) to a user for inhalation. Examples of such consumables include charges of tobacco material or capsules of liquid containing flavourants and active ingredients such as nicotine.

Aerosol generating devices often comprise a heater, a power source for supplying electricity to the heater and a receptacle, such as a heating chamber, for receiving the consumable in the vicinity of the heater such that the consumable may be heated to produce the vapour for inhalation.

In recent years the popularity of multiple use aerosol generating devices has surpassed that of single use devices which are disposed of after use. In multiple use devices the consumable must be replaced as the consumable can only provide the required active ingredients or flavourants for a limited duration of heating before these components are depleted. This is generally achieved by removing the depleted consumable from the heating chamber and replacing it with a new consumable.

There are however several shortcomings with such aerosol generating devices and systems. In particular, the replacement of the consumable is often an awkward process for the user, given the size of the components and the requirement to manoeuvre the aerosol generating device into the appropriate orientation while removing the spent consumable and replacing with a new consumable. This process has to be carried out regularly which exacerbates the problem. Furthermore, the arrangement of the consumable and heating chamber in conventional aerosol generating systems leads to many users finding the systems cumbersome to operate and hold during use. More specifically, many conventional aerosol generating systems require users to position their arm, wrist and hand in an awkward or uncomfortable manner while the system is operated and the user is inhaling a vapour.

Therefore, there is need to provide an aerosol generating device and system which addresses one or more of these issues.

### SUMMARY OF THE INVENTION

According to a first aspect of the present disclosure, there is provided an aerosol generating device comprising a heating chamber and a grip; wherein the heating chamber comprises an internal surface extending in a first direction; and wherein the grip is arranged parallel to a longitudinal axis of the device; such that the angle between the first direction and the longitudinal axis of the device is between 5° and 45°.

By providing an aerosol generating device with a heating chamber and a grip arranged in this manner, the device is able to be held in a more comfortable and natural position for the user, particularly during operation and inhalation, in terms of the angular relationship between holding the device and a mouthpiece of a consumable in the mouth of the user. This leads to an enhanced smoking experience and allows for an easier consumable replacement process.

The grip of the aerosol generating device may have a perimeter which is between 30 mm and 160 mm. This provides a means for the user to hold the aerosol generating device comfortably and securely irrespective of whether the device is in use.

Preferably, the aerosol generating device further comprises an air inlet passing from the exterior of the device into the heating chamber, the air inlet being located away from the grip. In this way, the air inlet allows air to enter the heating chamber while ensuring that the inlet is not covered by the user when holding the grip or using the device.

The heating chamber of the aerosol generating device may further comprise a bevelled opening. This provides a simple and easy means of inserting a consumable into the heating chamber. Furthermore, the bevelled opening reduces the likelihood of the consumable being damaged during insertion.

In some examples of the invention the aerosol generating device further comprises a heating element; wherein the heating element is a heater surrounding the heating chamber. In some further examples of the invention the heater is a film resistive heater.

In other examples of the invention the aerosol generating device further comprises a heating element; wherein the heating element is an electromagnetic inductor surrounding or positioned next to the heating chamber.

The heating element provides the device with a means of transferring heat to the consumable such that the consumable is heated and vapour is produced for inhalation. The heating element being positioned next to or surrounding the heating chamber allows for heating a large proportion of the consumable, facilitating a uniform constant heating and thus aiding in maintaining a controlled temperature in the heating chamber. In an example of the invention where the heating element is an electromagnetic inductor, surrounding or being positioned next to the heating chamber provides the generation of an efficient electromagnetic field through the heating chamber.

Preferably, the aerosol generating device further comprises a battery arranged parallel to the longitudinal axis of the device. The battery provides a power source for components of the device and arranging it in this manner lowers the risk of the battery being damaged by heat from the heating element and other components of the device.

Preferably, the aerosol generating device further comprises a printed circuit board (PCB) arranged parallel to the longitudinal axis of the device. Arranging the PCB in this manner reduces the risk of the PCB, or any connected components, being damaged by heat from the heating element and other components of the device.

As the first direction is angularly offset from the longitudinal axis of the device, the internal space of the device may be utilised more flexibly, for example with regards to component layout and distribution.

The aerosol generating device may further comprise a thermal insulator disposed around the heating chamber and/or between the heating element and the battery and/or the PCB. The incorporation of a thermal insulator disposed in the above described manner shields components of the device from heat. The thermal insulator may also improve the heating efficiency of the device due to less heat being transferred away from the heating chamber.

The aerosol generating device may have an elongate cross section in the plane perpendicular to the longitudinal axis of the device. This allows the device to be held comfortably and securely by the user. Preferably, this elongate cross section has a minimum width in the range of 15 mm and 25 mm and a maximum width in the range of 25 mm and 50 mm.

In another aspect of the invention there is provided an aerosol generating system comprising an aerosol generating device according to the first aspect of the invention and a consumable; wherein the consumable comprises a mouthpiece and a vapour generating substance; and wherein the heating chamber is arranged to receive the consumable in the first direction in use. The aerosol generating device has the essential features described in claim 1 and optionally any combination of the features described above. The mouthpiece being comprised in the consumable prevents the device becoming contaminated by the build-up of unwanted particulates and bacteria after repeated use. This also prevents undesired mixing of flavours from different types of vapour generating substances. The mouthpiece of the consumable further provides a means for the user to insert or remove the consumable from the system without contacting the vapour generating substance.

The consumable may be a straight stick or rod to facilitate easy insertion into the bevelled opening and/or heating chamber of the device as well as to facilitate removal from the device.

Preferably, the vapour generating substance of the consumable is solid or semi-solid. This reduces the risk of the vapour generating substance leaking and the user undesirably coming into contact with the vapour generating substance. Example types of solid vapour generating substances include powder, granules, pellets, shreds, strands, porous materials, foam or sheets.

In an aspect of the invention where the heating element is an electromagnetic inductor, the consumable may further comprise a susceptor. The susceptor absorbs electromagnetic energy from the electromagnetic inductor and converts the absorbed energy to heat.

The vapour generating substance may be any suitable substance capable of generating a vapour. The vapour generating substance may comprise plant derived material and in particular, the substance may comprise tobacco.

Preferably, the vapour generating substance may comprise an aerosol-former. Examples of aerosol-formers include polyhydric alcohols and mixtures thereof such as glycerine or propylene glycol. Typically, the vapour generating substance may comprise an aerosol-former content of between approximately 5% and approximately 50% on a dry weight basis. Preferably, the vapour generating substance may comprise an aerosol-former content of approximately 15% on a dry weight basis.

In the case of the aerosol generating device comprising an electromagnetic inductor the consumable may further comprise susceptor material such that the electromagnetic inductor heats the susceptor material in use. The susceptor material may comprise one or more, but not limited, of aluminium, iron, nickel, stainless steel and alloys thereof, e.g. nickel chromium.

In yet another aspect of the invention, there is provided a smoking device comprising a heating chamber and a PCB or battery; wherein the heating chamber comprises an internal surface extending in a first direction and is configured to accept a vapour generating substance, and wherein the PCB or battery is configured to extend along a second direction; wherein the angle between the first direction and the second direction is between 5° and 45°.

The aerosol generating device may comprise a user interface positioned away from the grip. The user interface may provide a means for the user to control the device and may additionally display information about the aerosol generating device or system such as heating chamber temperature or remaining consumable usage or battery power.

The aerosol generating device may have a substantially circular cross section in the plane perpendicular to the longitudinal axis of the device. Preferably, the substantially circular cross section has a diameter in the range of 10 mm and 35 mm. The substantially circular cross section may have bevelled edges such that it has the form of a circle with one or more circular segments removed.

The aerosol generating device may have a substantially ovoid cross section in the plane perpendicular to the longitudinal axis of the device. Preferably, the substantially ovoid cross section has a minimum diameter in the range of 15 mm and 25 mm and a maximum diameter in the range of 25 mm and 50 mm. The substantially ovoid cross section may have bevelled edges such that it has the form of an oval with one or more elliptical segments removed.

The consumable of the aerosol generating system may be crooked shaped such that the angle between the longitudinal axis of the device and the longitudinal axis of the mouthpiece is greater than the angle between the first direction and the longitudinal axis of the device. A consumable with a crooked shape provides further possibilities of system orientation during operation.

### BRIEF DESCRIPTION OF THE DRAWINGS

FIG. 1 is a schematic illustration of an aerosol generating system according to the present invention where the consumable and aerosol generating system are not coupled.

FIG. 2 is a schematic illustration of a close up view of the heating chamber and surrounding region of an aerosol generating device.

FIG. 3A shows an example of the aerosol generating system when the aerosol generating device has an elongate cross section in the plane perpendicular to the longitudinal axis of the device.

FIG. 3B shows the elongate cross section of the device of FIG. 3A.

FIG. 4A shows an example of the aerosol generating system when the aerosol generating device has a substantially circular cross section in the plane perpendicular to the longitudinal axis of the device

FIG. 4B shows the substantially circular cross section of the device of FIG. 4A.

FIG. 5A shows an example of the aerosol generating system when the aerosol generating device has a substantially ovoid cross section in the plane perpendicular to the longitudinal axis of the device

FIG. 5B shows the substantially ovoid cross section of the device of FIG. 5A.

### DETAILED DESCRIPTION

Examples of the present disclosure will now be described by way of example only and with reference to the accompanying drawings.

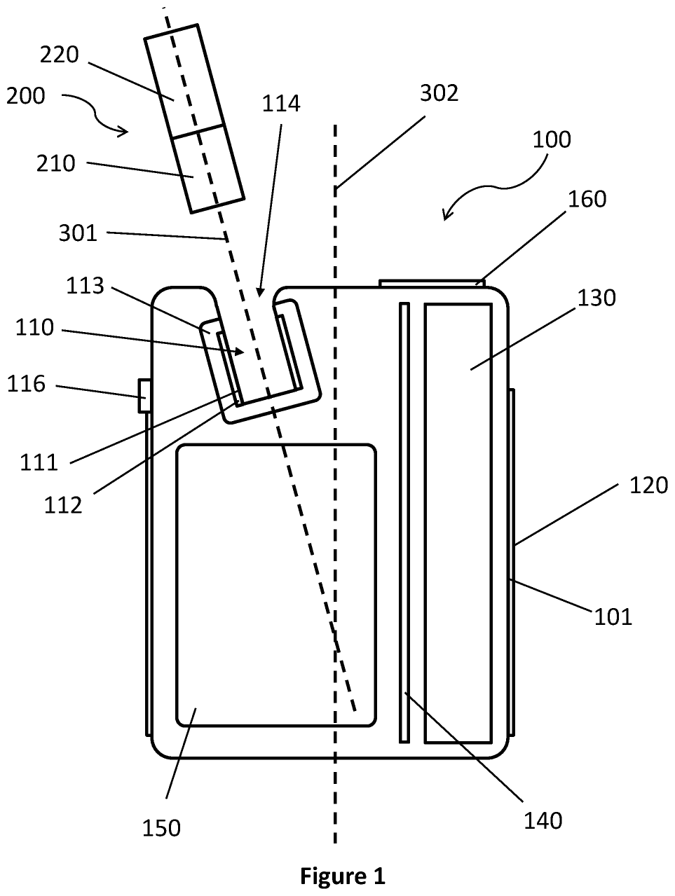

FIG. 1 shows an example of an aerosol generating system comprising an aerosol generating device 100 and a consumable 200 which has not been introduced to the device 100. The device 100 has an elongate body 101 with areas of the body 101 acting as a grip 120 for holding the device 100. There is a heating chamber 110 disposed at a first end of the body 101 and arranged to receive the consumable 200 and heat the consumable 200 to generate an inhalable vapour. The device 100 includes a heating element 112 surrounding the heating chamber 110 and a thermal insulator 113 surrounding the heating element 112. The device further comprises a printed circuit board (PCB) 140 and a battery 130 used to power the device 100 and its compositional components.

The consumable 200 shown in FIG. 1 comprises a mouthpiece 220 and a vapour generating substance 210. The vapour generating substance 210 may be solid, semi-solid or a liquid and generates a vapour upon heating. In this example, the vapour generating substance 210 is tobacco. After the vapour has been generated it is drawn through the consumable 200 and is inhaled by the user at the mouthpiece 220. The consumable 200 of FIG. 1 is substantially cylindrical with a straight stick or rod shape however this is not necessary and consumables 200 with alternate shapes are possible as long as they fit into the heating chamber 110 of the device 100. An example of a consumable with an alternate shape is a crooked rod where the mouthpiece 220 is angularly offset from the vapour generating substance 210.

The body 101 of the device 100 is formed such that the device 100 is able to be held and operated by a single hand of the user. In the example shown in FIG. 1, the device 100 is shaped to have an elongate cross section in the plane perpendicular to a longitudinal axis of the device 302 so that it may be comfortably and securely held by the user. The body 101 may be fashioned such that it innately acts as a grip 120 or, alternatively, the grip 120 may be an additional component connected to the outer faces of the body. This grip 120 enhances the comfort and secureness of the device 100 when held and operated. Preferably, the perimeter of the grip 120 is between 30 mm and 160 mm so as to ensure the device 100 may be comfortably held by the user.

The heating chamber 110 of the invention comprises an opening 114 and an internal surface 111 extending in a first direction 301. In a preferred example, the opening 114 of the heating chamber 110 is bevelled to allow for easier introduction of the consumable 200. When the consumable 200 is introduced to the heating chamber 110 it is received along the first direction 301 and enters into direct contact with the internal surface 111.

As shown in FIG. 1, the heating chamber 110 is arranged such that the axis of the first direction 301 and the longitudinal axis of the device 302 are not parallel to each other. Preferably these two axes form an angle between them in the range of 5° and 45°. Due to this arrangement, the device 100 possesses an ergonomic form which leads to an enhanced smoking experience.

Dimensions of the heating chamber 110 are approximately the same as the consumable 200 to allow frictional force between the consumable 200 and the internal surface 111 of the heating chamber 110 to reliably retain the consumable 200 in the heating chamber 110. There may also be provided on the consumable 200 and/or the heating chamber 110 a non-permanent fixing means or locking mechanism to more securely retain the consumable 200 in the heating chamber 110 while still allowing for the later removal of the consumable 200.

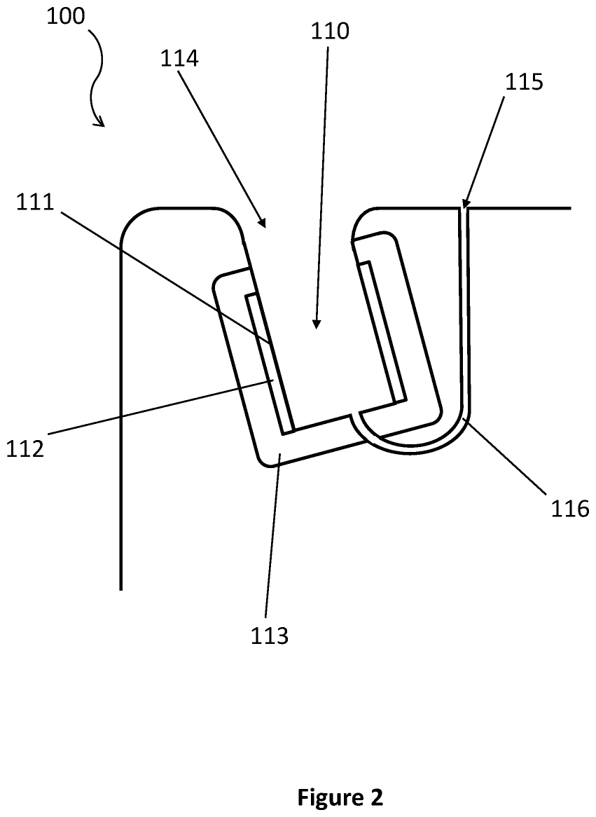

The device 100 is further provided with an air inlet 115 and an inlet passage 116 to link the exterior of the device 100 to the heating chamber 110. This allows the user to draw air and generated vapour through the consumable 200 for inhalation by way of the mouthpiece 220. Preferably, the air inlet 115 is located away from the grip 120 of the device 100 to avoid the air inlet 115 being covered by the user during operation, for example at the first end of the body 101 nearby the opening 114 of the heating chamber 110. A close up view of the device comprising the air inlet and inlet passage is shown in FIG. 2.

A heating element 112 is arranged nearby the heating chamber 110 of the device 100 to provide a means of transferring heat to the vapour generating substance 210. As shown in FIGS. 1 and 2, the heating element 112 surrounds the heating chamber 110 so as to uniformly heat the substance 210 and generate the vapour more efficiently. Positioning the heating element 112 closer to the heating chamber 110 further increases the power efficiency of the device 100 as less heat is lost between the heating element 112 and heating chamber 110. Examples of possible heating elements 112 are a heater, such as a film resistive heater, and an electromagnetic inductor. The device 100 may be provided with a thermal insulator 113 to protect heat sensitive components of the device 100 from heat generated by the heating element 112. The thermal insulator 113 may additionally increase the power efficiency of the device 100 as less heat is transferred to components other than the heating chamber 110 and consumable 200. In this example the thermal insulator 113 surrounds both the heating element 112 and the heating chamber 110 however other locations and arrangements may provide further benefits. For example, the thermal insulator 113, or an additional thermal insulator, may be disposed nearby the PCB 140 or battery 130, so that the insulator 113 is between the heating element 112 and the PCB 140 or battery 130, if these components are particularly heat sensitive.

The device 100 shown in FIG. 1 comprises a PCB 140 and battery 130 which are arranged substantially parallel to the longitudinal axis of the device 302. The PCB 140 and battery 130 are arranged in this manner to maximise usage of internal space of the device 100 while mitigating the risk that these components are damaged by the heating element 112. The battery 130 provides power to the components of the device 100 and is connected to, for example, the PCB 140 and heating element 112. There may also be provided an activation means such as a switch or button 116 to allow the user to selectively apply power to the heating element 112. FIG. 1 also shows a possible internal region of the device where other components 150 may be disposed if required.

In some examples the device 100 may further comprise a user interface 160 as a means of displaying information. Displayed information may include the battery power level or an indicator as to whether the temperature of the heating chamber 110 is sufficient to heat the consumable 200 and generate a vapour.

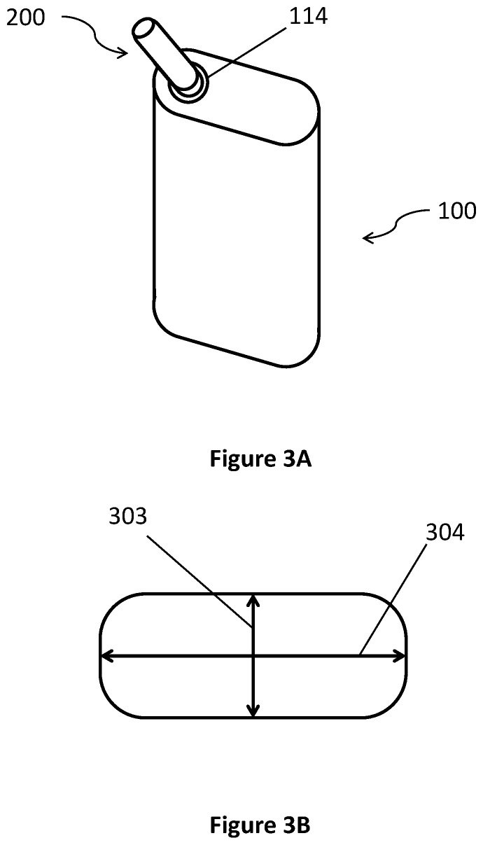

FIGS. 3A-B show an example of the aerosol generating device 100 where the device 100 has a elongate cross section in the plane perpendicular to the longitudinal axis of the device 302. Preferably, the elongate cross section has a minimum width 303 in the range of 15 mm and 25 mm and a maximum width 304 in the range of 25 mm and 50 mm.

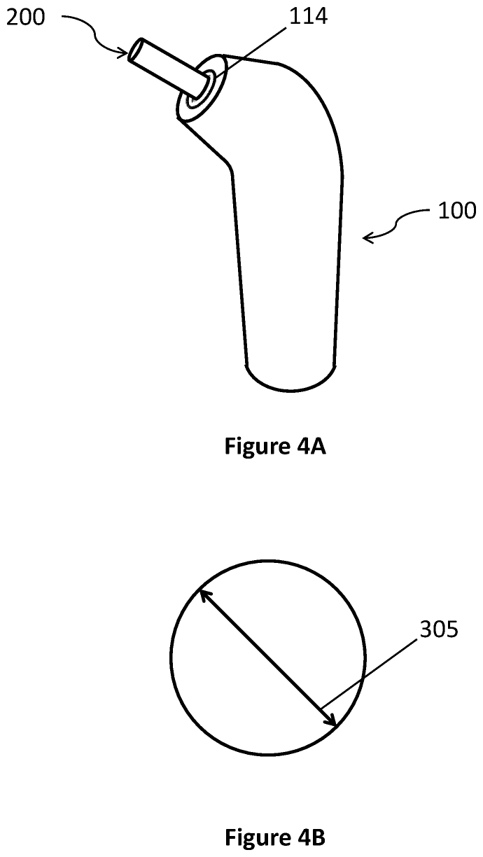

FIGS. 4A-B show an alternate example of the aerosol generating device 100 with a substantially circular cross section in the plane perpendicular to the longitudinal axis of the device 302. Preferably, the substantially circular cross section has a diameter 305 in the range of 10 mm and 35 mm.

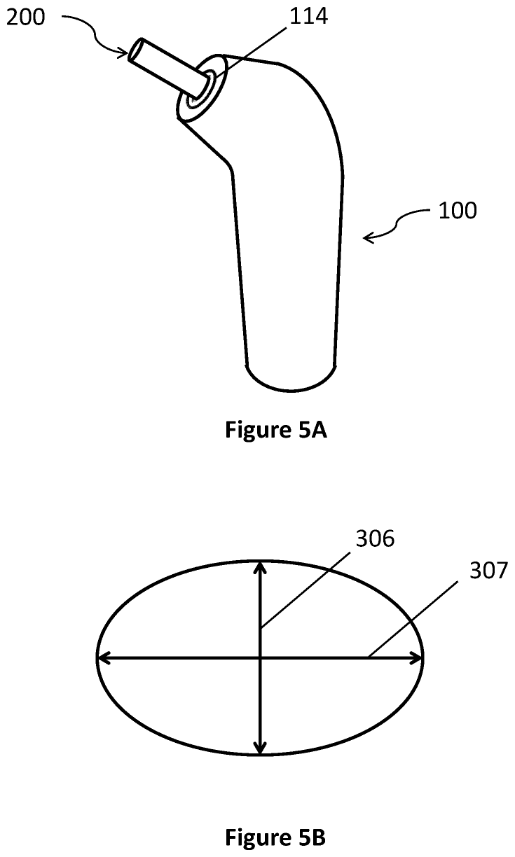

FIGS. 5A-B show another alternate example of the aerosol generating device 100 with a substantially ovoid cross section in the plane perpendicular to the longitudinal axis of the device 302. Preferably, the substantially ovoid cross section has a minimum diameter 306 in the range of 15 mm and 25 mm and a maximum diameter 307 in the range of 25 mm and 50 mm.

As will be appreciated from the above description, the present invention provides an aerosol generating device 100 and aerosol generating system with a heating chamber 110 and grip 120 which are angularly offset to one another. This allows for the user to hold the device 100 in a more comfortable and natural position which particularly improves the smoking experience during vapour inhalation as well as the consumable 200 replacement process.

1. An aerosol generating device comprising: a body, a heating chamber, a battery, and a PCB;
wherein the body comprises a grip arranged parallel to a longitudinal axis of the device;
the heating chamber, the battery, and the PCB are arranged within the body; and
the heating chamber comprises an internal surface extending in a first direction, and the heating chamber is configured to receive a consumable along the first direction;
such that an angle between the first direction and the longitudinal axis of the device is between 5° and 45°.

2. The aerosol generating device of claim 1, wherein a perimeter of the grip is between 30 mm and 160 mm.

3. The aerosol generating device of claim 1, further comprising an air inlet passing from an exterior of the device into the heating chamber, the air inlet being located away from the grip.

4. The aerosol generating device of claim 1, wherein the heating chamber further comprises a bevelled opening.

5. The aerosol generating device of claim 1, further comprising a heating element; wherein the heating element is a heater surrounding the heating chamber.

6. The aerosol generating device of claim 1, further comprising a heating element, wherein the heating element is an electromagnetic inductor surrounding or positioned next to the heating chamber.

7. The aerosol generating device of claim 1, wherein the battery is arranged parallel to the longitudinal axis of the device.

8. The aerosol generating device of claim 1, wherein the PCB is arranged parallel to the longitudinal axis of the device.

9. The aerosol generating device of claim 5, further comprising a thermal insulator disposed around the heating chamber and/or between the heating element and the battery and/or the PCB.

10. The aerosol generating device of clam 1, wherein the aerosol generating device has an elongate cross section in a plane perpendicular to the longitudinal axis of the device.

11. The aerosol generating device of claim 10, wherein the elongate cross section has a minimum width in a range of 15 mm and 25 mm and a maximum width in a range of 25 mm and 50 mm.

12. An aerosol generating system comprising the aerosol generating device of claim 1 and a consumable;
wherein the consumable comprises a mouthpiece and a vapour generating substance.

13. The aerosol generating system of claim 12, wherein the consumable is a straight stick or rod.

14. The aerosol generating system of claim 12, wherein the vapour generating substance is solid or semi-solid.

15. A smoking device comprising a heating chamber and a PCB or a battery;
wherein the heating chamber comprises an internal surface extending in a first direction and is configured to accept a vapour generating substance; and
wherein the PCB or the battery is configured to extend along a second direction;
wherein an angle between the first direction and the second direction is between 5° and 45°.
